(19) United States
(12) Patent Application Publication
(10) Pub. No.: US 2014/0095555 A1
(43) Pub. Date: Apr. 3, 2014

(54) FILE MANAGEMENT DEVICE AND METHOD FOR STORAGE SYSTEM

(71) Applicant: SAMSUNG ELECTRONICS CO., LTD., Suwon-Si (KR)

(72) Inventors: JAE-GEUK KIM, HWASEONG-SI (KR); CHANG-MAN LEE, SEOUL (KR); CHUL LEE, HWASEONG-SI (KR); JOO-YOUNG HWANG, SUWON-SI (KR)

(73) Assignee: SAMSUNG ELECTRONICS CO., LTD., Suwon-Si (KR)

(21) Appl. No.: 14/038,891

(22) Filed: Sep. 27, 2013

(30) Foreign Application Priority Data
Sep. 28, 2012 (KR) 10-2012-0109254

(51) Int. Cl. G06F 17/30

(52) U.S. Cl. CPC G06F 17/30218
USPC 707/823; 707/827

(57) ABSTRACT

A file management device for a storage system includes a virtual file system (VFS) having a read-ahead (RA) management unit that stores RA management information and generates a first read request, and a file system that receives first read data in response to the first read request and second read data in response to a previously received read request, compares the first and second read data to generate varying information related to the RA management information, and provides the varying information to the VFS, wherein the VFS updates the RA management information in response to the varying information.

### CROSS-REFERENCE TO RELATED APPLICATIONS

This application claims the benefit of Korean Patent Application No. 10-2012-0109254 filed on Sep. 28, 2012, the subject matter of which is hereby incorporated by reference.

### BACKGROUND

The inventive concept relates to file management devices and file management methods that may be used to access data in data storage systems making use of a virtual file system.

When reading a file stored in a storage system, a host computer may perform one or more sequential access operations, or random access operations. Certain operating systems (OS) used in contemporary data processing and digital platforms (e.g., computers) utilize a so-called “read-ahead” (RA) scheme of operation. In a RA operating scheme, one or more computational methods is used to ‘predict’ certain data that is likely to be accessed. That is, RA schemes seeks to identify likely “next” read data before said read data is actually identified in relation to a data access operation. When successfully performed, RA schemes improve read performance of a data storage system.

However, when a size of a RA slide is adjusted in a virtual file system, it becomes very complicated to determine a read access pattern using requested position information in a case where multiple read streams are requested. Also, it is burdensome for a programmer to process operations one by one to improve RA performance by enabling an application to notify a constituent virtual file system about whether the application sequentially accesses or randomly accesses a file.

### SUMMARY

The inventive concept provides a file management device and a file management method that enable a read-ahead (RA) scheme performed by a virtual file system. According to an aspect of the inventive concept, there is provided a file management apparatus of a storage system including; a virtual file system (VFS) having a read-ahead (RA) management unit that stores RA management information and configured to generate a current read request and a file system configured to receive first read data in response to the current read request and second read data in response to a previously received read request, compare the first and second read data to generate varying information related to the RA management information, and provide the varying information to the VFS, wherein the VFS is further configured to update the RA management information in response to the varying information.

According to another aspect of the inventive concept, there is provided a method of managing files stored in a storage system using a file management device including a virtual file system (VFS) and a file system, the method including; generating a first read request using the VFS, using the file system, reading first read data in response to the first read request and current read-ahead (RA) management information and comparing the first read data with second read data previously stored in storage system, and generating varying information in the file system based on the comparison of the first and second read data and communicating the varying information from the file system to the VFS, and updating the RA management information in the VFS in response to the varying information.

According to another aspect of the inventive concept, there is provided a method of managing files stored in a storage system using a file management device including a virtual file system (VFS) and a file system, the method including; executing in the VFS a read-ahead (RA) scheme based on current RA management information to predict data stored in the storage system to be next accessed, wherein the current RA management information is defined in relation to a first data pattern of first data stored in the storage system, reading second data stored in the storage system having a second data pattern different from the first data pattern using the file system, generating varying information in the file system based on a comparison of the first and second data patterns and communicating the varying information from the file system to the VFS, and updating the current RA management information in the VFS in response to the varying information to generate new RA management information.

### BRIEF DESCRIPTION OF THE DRAWINGS

The making and use of inventive concept may be readily understood upon consideration of certain embodiments some of which are illustrated in the accompanying drawings in which:

FIG. 1 is a block diagram illustrating a general computer system including a file management device according to embodiments of the inventive concept;

FIG. 2 is a block diagram further illustrating the file management device of FIG. 1;

FIG. 3 is a flowchart summarizing a file management method that may be performed by the file management device of FIGS. 1 and 2 according to embodiments of the inventive concept;

FIG. 4 is a block diagram further illustrating a file management device in a case where RA management information is slide size information (RA_Slide) according to embodiments of the inventive concept;

FIG. 5 is a block diagram illustrating one example of a file system according to embodiments of the inventive concept;

FIG. 6, inclusive of FIGS. 6A, 6B and 6C, illustrates a file system becoming fragmented;

FIG. 7 is a diagram illustrating the state of stored data relative to a storage type determining unit;

FIG. 8 is a flowchart summarizing a file management method that may be performed by a file management device of a storage system according to embodiments of the inventive concept;

FIG. 9 is a block diagram illustrating a file management device in a case where RA management information is disk defragmentation execution information (RE_ARA) for data according to embodiments of the inventive concept;

FIG. 10 is a block diagram illustrating a file system according to embodiments of the inventive concept;

FIG. 11 is a diagram illustrating the state of stored data in relation to a storage type determining unit; and

FIGS. 12 and 13 are respective flowcharts that summarize file management methods that may be performed by a file management device of a storage system according to embodiments of the inventive concept.

### DETAILED DESCRIPTION

Certain embodiments of the inventive concept will now be described in some additional detail with reference to the accompanying drawings. The inventive concept may, however, be embodied in many different forms and should not be construed as being limited to only the illustrated embodiments. Rather, these embodiments are provided so that this disclosure will be thorough and complete, and will fully convey the concept of the inventive concept to those of ordinary skill in the art. Throughout the written description and drawings, like reference numbers and labels are used to denote like or similar elements.

While specific terms were used in the specification, they were not used to limit the meaning or the scope of the inventive concept described in following claims, but merely used to explain the inventive concept. The terms of a singular form may include plural forms unless otherwise specified. Also, the meaning of “include,” “comprise,” “including,” or “comprising,” specifies a property, a region, a fixed number, a step, a process, an element and/or a component but does not exclude other properties, regions, fixed numbers, steps, processes, elements and/or components.

It will be understood that, although the terms first, second, third etc. may be used herein to describe various elements, components, and/or sections, these elements, components, and/or sections should not be limited by these terms. These terms are only used to distinguish one element, component, or section from another element, component, or section. Thus, a first element, component, or section discussed below could be termed a second element, component, or section without departing from the teachings of example embodiments.

Terms and words used in the embodiments and claims should not be limitedly construed as those commonly used or defined in dictionaries, but should be construed as having meanings and as concepts which comply with the spirit of the embodiments of the present disclosure on the basis of a principle that the concepts of the terms can be properly defined to describe the embodiments in the best way.

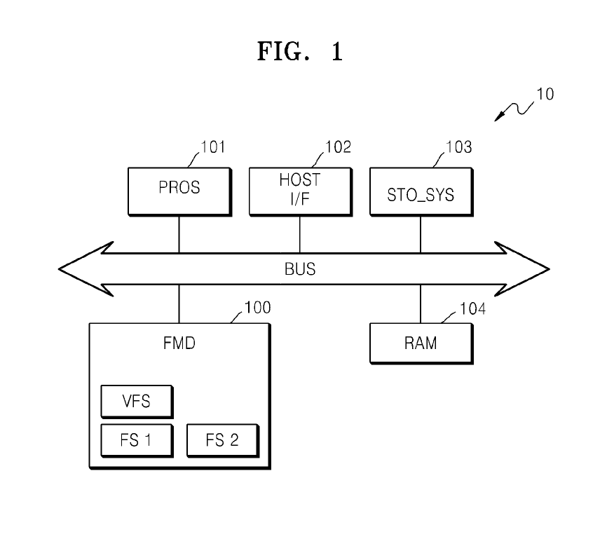

Figure (FIG. 1 illustrates a general computer system 10 including a file management device (FMD) according to embodiments of the inventive concept. Referring to FIG. 1, the computer system 10 comprises a host interface (I/F) 102, a storage system (STO_SYS) 103, a processor (PROS) 101, a random access memory (RAM) 104, as well as a file management device (FMD) 100.

The host interface 102 may be used to receive a “request” (such as a data access request with or without accompanying data) from a connected host (not shown), and communicate the request to the processor 101 and to communicate the data accompanying the request, if any, to the storage system 103.

The processor 101 may be used to generally control the file management device 100, and to control the exchange of data between the storage system 103, the RAM 104, and the host in response to various requests.

The RAM 104 may be a dynamic RAM (DRAM) or a static RAM (SRAM), and in many operations executed by the computer system 10 the RAM 104 will serve as a buffer memory.

The file management device 100 of FIG. 1 includes a virtual file system (VFS) and at least one file system (e.g., a first file system FS1 and a second file system FS2). The VFS may enable an application being executed by the computer system 10 to access one or more of the available file systems FS1 and FS2. Thus, the VFS may be understood as an interface between the operating system (OS) of the computer system 10 and its constituent file systems FS1 and FS2.

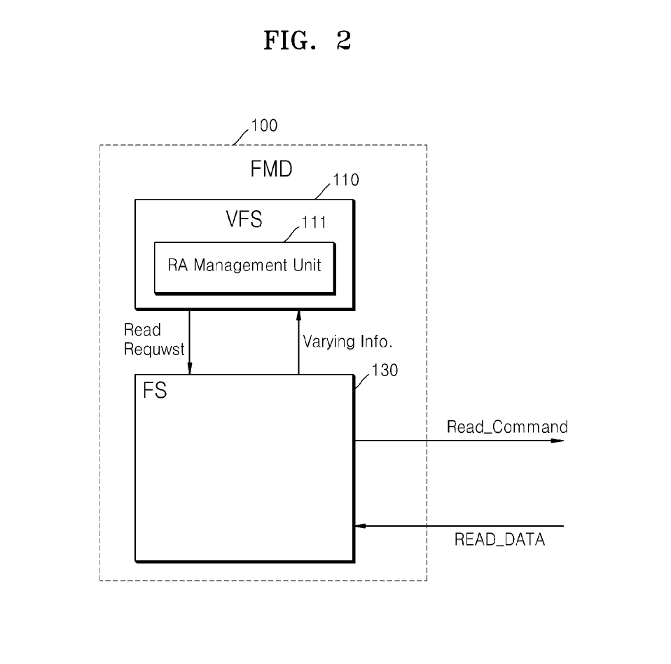

According to certain embodiments of the inventive concept, a VFS may include a “read-ahead” (RA) management unit (see, FIG. 2) that may be used to store RA management information, generate a “Read request” on the basis of the RA management information, and communicate the Read request to the file systems FS1 and FS2. The file systems FS1 and FS2, in response to the RA management information and a Read request, may read data stored in the RAM 104 and create so-called “varying information”. Upon receiving this varying information, the VFS may use it to implement RA management functions.

FIG. 2 further illustrates the file management device 100 of FIG. 1 according to an embodiment of the inventive concept. Referring to FIG. 2, the file management device (FMD) 100 comprises a virtual file system (VFS) 110 and a file system (FS) 130.

The VFS 110 includes a RA management unit 111 that stores RA management information. The RA management information may include, for example, RA slide size information and/or disk defragmentation execution information. Throughout the subject specification, the term “RA slide size information” is used to denote certain information regarding the number of “data pieces” (e.g., data sets that may be individually identified) that result from a reading-ahead scheme. The term “disk defragmentation execution information” is used to denote information that may use to execute or not-to-execute a defragmentation operation for the storage system 103.

The VFS 110 may be used to provide a Read request from the host to the file system 130, and to receive corresponding varying information (info.) that may be used to modify (or update) existing RA management information stored in the RA management unit 111.

Thus, the file system 130 may be used to communicate a “Read_Command” to an external storage system (not shown in FIG. 2, but see storage system 103 of FIG. 1) in response to the Read request received from the VFS 110. As will be appreciated by those skilled in the art, the external storage system may be a solid state drive (SSD) or a hard disk drive (HDD). Alternatively, the external storage system may include a semiconductor memory cell array or a controller that controls the operation of a semiconductor memory cell array. In certain embodiments, a semiconductor memory cell array may include a phase random-access memory (PRAM), a magneto-resistive random-access memory (MRAM), a resistive random-access memory (ReRAM), a ferroelectric random-access memory (FRAM), a NOR flash memory, a NAND flash memory, and a fusion flash memory including at least two memories from among the above-described memories, for example, a memory where a static random-access memory (SRAM) and the NAND flash memory are combined with a NOR interface logic. When the external storage system includes at least two memories, at least two file systems 130 may be used to drive the memories.

In one embodiment of the inventive concept, the file system 103 may further be used to receive “read data” (READ_DATA) in response to the read command (Read_Command) communicated to the external storage system, and generate the varying information (Varying Info.) using the read data.

In this manner, the VFS 110 may receive varying information and used the varying information to update existing RA management information that may, in turn, be used to perform RA operations with respect to subsequently received read requests.

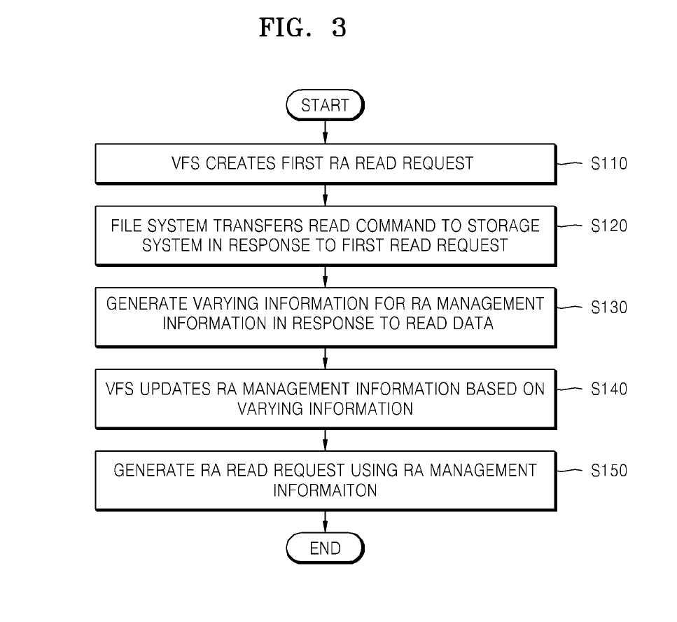

FIG. 3 is a flowchart summarizing a file management method that may be used by the file management device 100 of FIGS. 1 and 2 according to embodiments of the inventive concept.

Referring to FIGS. 1, 2 and 3, the VFS 110 generates a first Read request and communicates same to the file system 130 (S110). The file system 130 then generates and communicates a corresponding read command in response to the first Read request to the storage system 103 (S120). In response to the read command, the storage system 103 provides “new” RA read data, as identified by the read command. This new RA read data may be stored in a buffer memory.

The file system 130 receives a the new RA read data specified by the Read request, and using the new RA read data in conjunction with “old” (i.e., existing or previously retrieved), the file system generate the varying information that may be used to modify (or update) the RA management information (S130). Upon receiving the varying information, the VFS 110 may update a current version of the RA management information on the basis of the varying information (S140). Thereafter, subsequent Read requests will be generated by the VFS 110 using the (updated) RA management information (S150).

Since a file management method according to embodiments of the inventive concept generate varying information in a file system, the VFS may update (i.e., modify or vary) RA management information to be more suitable given a current read access pattern. This approach may be implemented without use a complex algorithm that characterizes conventional read-ahead schemes, and may be used even when multiple read streams running In addition, the operating system (OS) for the computer system 10 itself may resolve a dynamic RA mechanism without the necessity of RA management process operations that require multiple iterations per multiple applications.

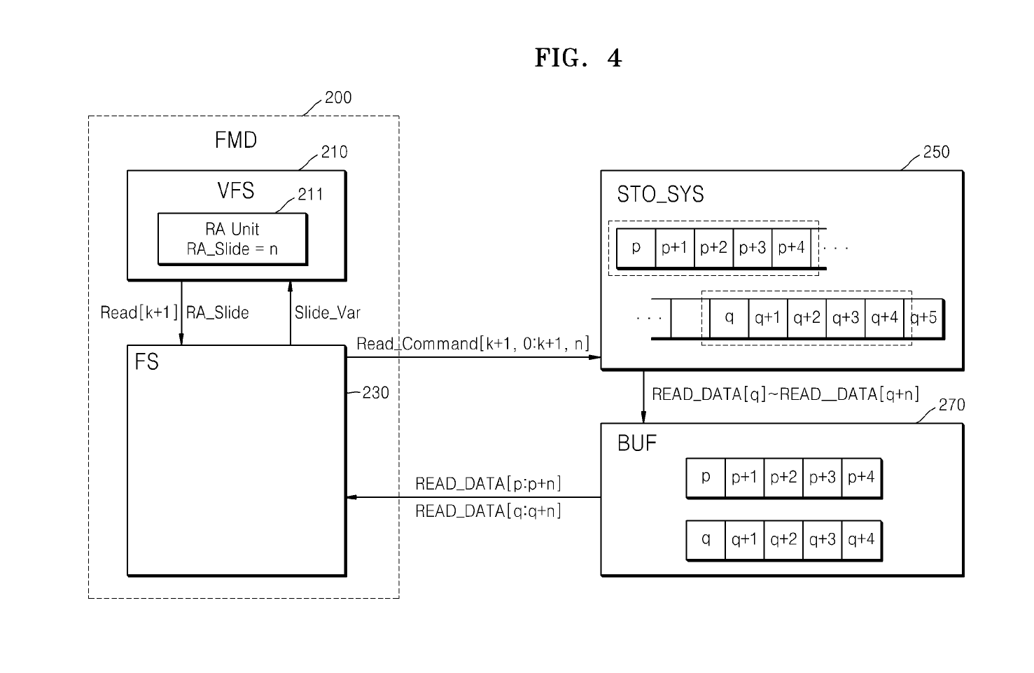

FIG. 4 is a block diagram illustrating a file management device 200 capable of generating dynamically updated RA management information according to a RA slide size information (RA_Slide) according to certain embodiments of the inventive concept.

Referring to FIG. 4, the file management device 200 includes a virtual file system (VFS) 210 and a file system (FS) 230. The VFS 210 includes an RA management unit 211 that defines a RA_Slide of “n”, where n is a positive integer. In certain embodiments, the RA_Slide may be information indicating how much data is to be read following an address at which “target data” of a read request Read [K+1] will be stored. For example, when the RA_Slide is 4 and a target data address associated with the read request Read [K+1] is “q”, then the file system 230 may request read data corresponding to addresses [q+1] through [q+4] in the storage system STO_SYS 250.

According to another embodiment, the VFS 210 may receive a single read request via a host interface (see HOST I/F of FIG. 1) and transmit a plurality of read requests that number as many as the RA slide size information (RA_Slide) appropriate to the file system 230.

The file system 230 may then communicate Read_Commands [k+1, 0:k+1, n] in response to Read [k+1] communicated from the VFS 210 to the storage system 250.

A controller included in the storage system 250 may read first data READ_DATA[q] to READ_DATA [q+n] in response to Read_Command [k+1, 0:k+1, n] transferred from the file system 230, and stores the read first data READ_DATA[q] to READ_DATA [q+n] in the buffer BUF 270. Through this process, the buffer 270 stores the first data READ_DATA[q] to READ_DATA [q+n] in response to the read request Read [k+1]. Also, the buffer 270 stores second data READ_DATA [p] to READ_DATA [p+n] read in response to a second read request Read [k] which is input to the file system 230 before the read request Read [K+1].

The file system 230 according to embodiments of the inventive concept may receive the first data READ_DATA[q] to READ_DATA[q+n] in response to Read_Command [k+1, 0:k+1, n] transferred to the storage system 250 and the second data READ_DATA[p] to READ_DATA [p+n] read in response to the second read request Read [k] which is input to the file system before the read request Read [K+1] and generate a RA slide size varying information (Slide_Var) in response to the first and second data Read_Data. The VFS 210 receiving the RA slide size varying information (Slide_Var) may update existing RA slide size information (RA_Slide) in response to the RA slide size varying information (Slide_Var) and thereafter perform RA operations using the updated RA slide size information (RA_Slide).

A file management device (FMD) according to embodiments of the inventive concept may vary RA slide size information to be appropriate for a current read access pattern in a data storage system (SDD or HDD) without implementation of a complex algorithm in the VFS, even when multiple read streams are requested, because the file system 230 generates the RA slide size varying information Slide_Var. Also, the operating system OS itself may solve an RA mechanism without the necessity of RA management process operations one by one operation performed by a programmer who programs the application.

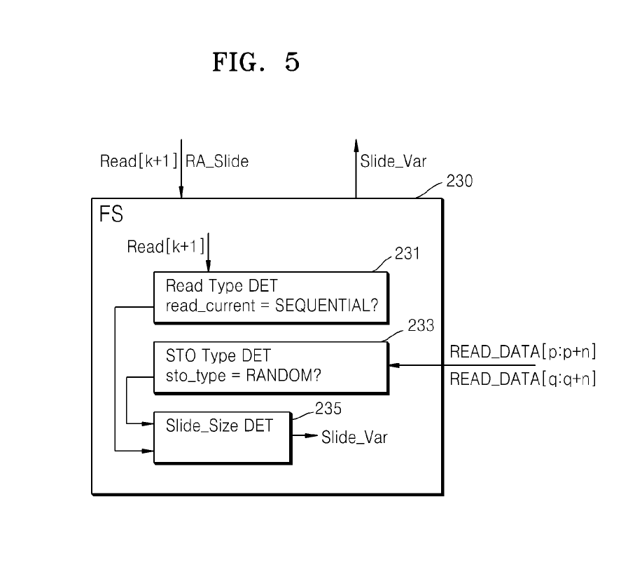

FIG. 5 is a block diagram further illustrating the file system 230 of FIG. 4 according to embodiments of the inventive concept. Referring to FIG. 5, the file system 230 includes a read type determination unit (Read Type DET) 231, a storage type determination unit (STO Type DET) 233, and a slide size determination unit (Slide_Size DET) 235.

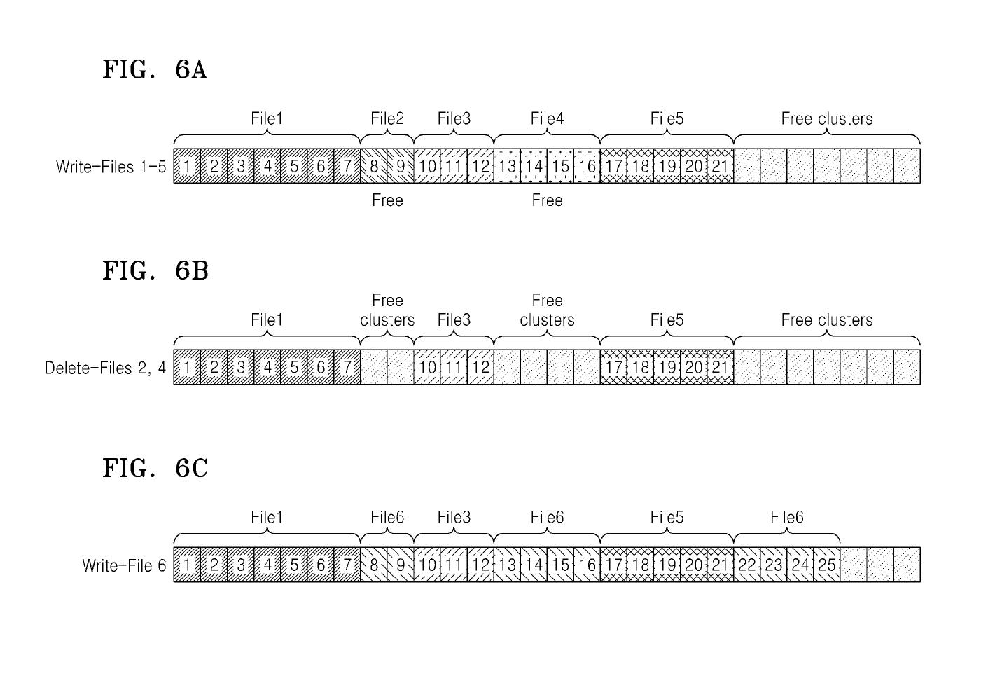

The read type determination unit 231 receives a read request [k+1]. The read type determination unit 231 compares a currently received first read request with a previous second request and determines whether the first and second read requests are sequential. For example, when the currently received first read request corresponds to a (k+1)-th frame and the previously received second read request corresponds to a k-th frame in read requests for a video file, a current read request is determined to be performed sequentially. A somewhat more detailed description will be provided below in relation to FIG. 6.

FIG. 6, inclusive of FIGS. 6A, 6B and 6C, illustrates one possible file system that may be used in conjunction with a defragmentation process.

FIG. 6A illustrates a case where first to fifth files (File 1-File 5) are written immediately after initialization of the file system, namely, immediately after an operation which is called formatting is performed. The first to fifth files are sequentially allocated to a plurality of clusters 1 to 21 which correspond to file sizes. A plurality of free clusters also exist.

Then, when the second file (File 2) and the fourth file (File 4) are deleted, and a sixth file (File 6) is written, the clusters 8 to 9 and 13 to 16 allocated to the second file and the fourth file become free clusters as shown in FIG. 6B.

It may be seen that the sixth file is allocated to the free clusters 8 to 9, 13 to 16, and 22 to 25 as shown in FIG. 6C. Thus, the sixth file written to the file system of FIG. 6C is stored in a non-volatile memory which corresponds to physical block addresses (PBA, hereinafter, referred to as “physical addresses”) of a non-volatile data storage device, which are mapped to logical block addresses (LBA, hereinafter, referred to as “logical addresses”) of the clusters 8 to 9, 13 to 16, and 22 to 25 to which the sixth file is allocated.

The file system allocates a plurality of clusters corresponding to an entire file size to a file when the file is generated. Although the clusters are sequentially allocated to files in a case where the files are generated in an initial time when the file system is formatted, the file system becomes fragmented due to frequent file creations and deletions during continuous usage of the file system.

When a large size file is written, discontinuous clusters may be allocated due to fragmentation of the file system. Then, data may be randomly written to a memory device and later may be randomly read by using logical addresses to be mapped to discontinuous cluster information.

Referring to FIGS. 5 and 6C, the read type determination unit 231 may be used to determine whether a current read request is directed to a sequential logical addresses of a file that is the same as a file corresponding to a previously received read request. The sequential logical addresses of a same file indicates that a logical address value of subject data of the first read request is greater than a logical address value of subject data of the previously received read request, and that there is no other data for the same file between the logical address value of subject data of the current read request and the logical address value of subject data of the previously received read request.

For example, for the sixth file, when a read request for the sixth file is sequentially performed on the clusters 8 to 9, 13 to 16 and 22 to 24 according to cluster numbers, the read request is determined to be sequential. For example, when the subject data of the current read request is stored in a cluster 13, and the subject data of the previously received read request is stored in a cluster 9, the current read request is determined to be sequential.

As another example, when a read request is performed on the third file after a read request for the sixth file, the current read request is determined to be random, not sequential.

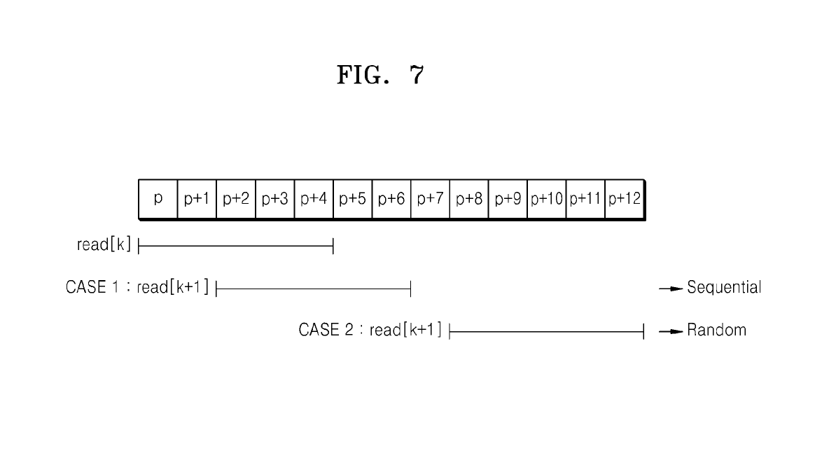

FIG. 7 is a diagram illustrating status of stored data as controlled by the storage type determining unit of FIGS. 5 and 6.

Referring to FIGS. 5, 6 and 7, the storage type determination unit 233 receives first and second data and determines whether data stored in the storage system is randomly stored. For example, when the second data does not include the same data as the first data, the storage type determination unit 233 may not determine the first data and the second data are stored sequentially. Namely when the second data does not include the same data as the first data, the storage type determination unit 233 may determine that the first and second data are stored randomly.

For example, when the second data read in response to the second read request Read [k] corresponds to READ_DATA [p] to READ_DATA [p+4], the second data read in response to the first read request Read [k+1] corresponds to READ_DATA [p+2] to READ_DATA [p+6], the storage type determination unit 233 determines the storage type to be sequential (CASE 1).

For example, when the data read in response to the read request Read [k] corresponds to READ_DATA [p] to READ_DATA [p+4], the data read in response to the read request Read [k+1] corresponds to READ_DATA [p+8] to READ_DATA [p+12], the storage type determination unit 233 determines the storage type to be random (CASE 2).

Referring to FIG. 5, the slide size determining unit 235 determines whether to increase the slide size on the basis of a determination result of the storage type determining unit 233. For example, when a read type determined by the read type determination unit 231 is sequential and a storage type determined by the storage type determination unit 233 is random, RA slide size varying information Slide_Var may be generated to increase RA slide size information RA_Slide. The degree of variation for a RA slide size may differ for various embodiments of the inventive concept.

For example, according to other embodiments of the inventive concept, when a read type determined by the read type determination unit 231 is random and a storage type determined by the storage type determination unit 233 is random, RA slide size varying information Slide_Var may be generated to decrease RA slide size information RA_Slide. According to still other embodiments of the inventive concept, when a read type determined by the read type determination unit 231 is random and a storage type determined by the storage type determination unit 233 is sequential, RA slide size varying information Slide_Var may be generated to decrease RA slide size information RA_Slide.

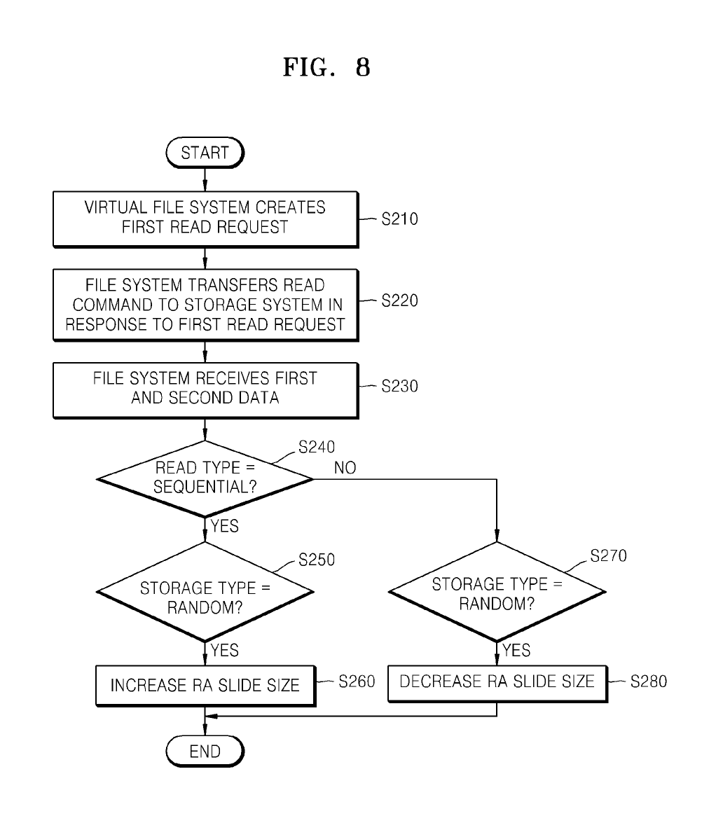

FIG. 8 is a flow chart summarizing a file management method that may be used by the file management device 200 of FIG. 5 according to embodiments of the inventive concept.

Referring to FIGS. 4, 5, and 8, the VFS 210 generates a first read request Read [k+1] (S210). The first read request Read [k+1] generated by the VFS 210 is transferred to the file system 230. The file system 230 transfers a read command Read_Command [k+1, 0:k+1, n] to the storage system 250 in response to the first read request Read [k+1] (S220).

The storage system 250 may store the read data in the buffer 270 in response to the read command Read_Command [k+1, 0:k+1, n]. The file system 230 receives data READ_DATA[q] to READ_DATA [q+n] and READ_DATA[p] to READ_DATA [p+n] read from the buffer 270 (S230).

The file system 230 may generate RA slide size varying information Slide_Var in response to the read data READ_DATA [q] to READ_DATA [q+n] and READ_DATA [p] to READ_DATA [p+n]. That is, the read type determination unit 231 determines whether the received read request Read [k+1] is sequential (S240).

The storage type determination unit 233 determines whether the storage type is random (S250 and S270). When the read request Read[k+1] is sequential and the storage type is random, RA slide size varying information Slide_Var may be generated to increase RA slide size information RA_Slide (S260).

When the read request Read [k+1] is random and the storage type is random, RA slide size varying information Slide_Var may be generated to decrease RA slide size information RA_Slide (S280).

From the foregoing it may be appreciated that a file management method according to an embodiment of the inventive concept may generate varying information using a file system. That is, a file management method according to an embodiment of the inventive concept may update (i.e., modify or vary) existing RA management information to be appropriate for a read access pattern without having to implement of a complex algorithm in the VFS, even when multiple read streams are requested, because the file system 230 generates varying information. Also, the operating system OS itself may solve an RA mechanism without the necessity of RA management process operations one by one by a programmer who programs the application.

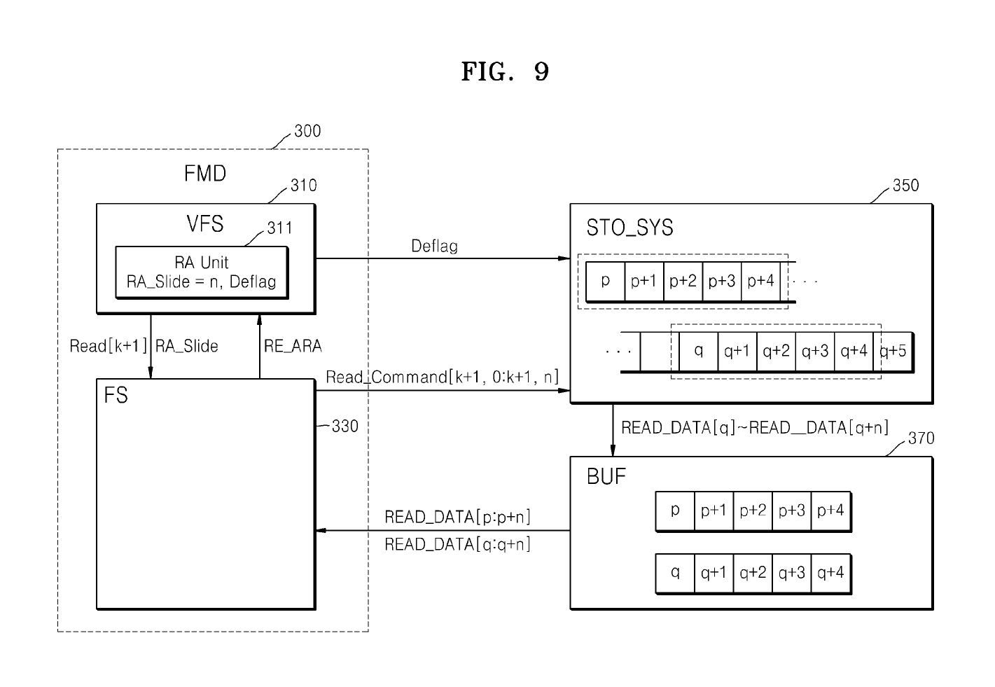

FIG. 9 is a diagram illustrating a file management device 300 in a case where RA management information is data defragmentation execution determination information (RE_ARA).

Referring to FIG. 9, the file management device 300 includes a virtual file system (VFS) 310 and a file system (FS) 330. The VFS 310 includes an RA management unit 311 that may include RA slide size information RA_Slide. The RA slide size information RA_Slide may be n (where n is an integer equal to or greater than 1). The RA slide size information RA_Slide will be described in detail with reference to the description in relation to FIG. 4.

In another embodiment of the present inventive concept, the VFS 310 receives one read request from a host interface (HOST I/F of FIG. 1) and transmits a plurality of read requests that number as many as the RA slide size information RA_slide to the file system 330.

The file system 330 transfers a read command Read_Command [k+1:k+1, n] in response to a read request Read [k+1] transferred from the VFS 310 to a storage system STO_SYS 350. The storage system 350 will be described below in detail with reference to FIG. 4.

The storage system 350 reads READ_DATA[q] to READ_DATA [q+n] in response to a read command Read_Command [k+1,0:k+1, n] transferred from the file system 330, and stores the read data in a buffer BUF 370. Through these processes, data READ_DATA[q] to READ_DATA [q+n] read in response to a read request Read [k+1] is stored in the buffer 370. In addition, for example, read data READ_DATA[p] to READ_DATA[p+n] in response to a read request Read [k], which is input to the file system before a read request Read [k+1], is also stored in the buffer 370.

A file system 330 according to an embodiment of the present inventive concept receives first data READ_DATA[q] to READ_DATA [q+n] read in response to a read command Read_Command [k+1,0:k+1, n] transferred to the storage system 350, and second data READ_DATA [p] to READ_DATA [p+n] read in response to a second read request Read [k] which is input to the file system before the read request Read [k+1], and generates defragmentation execution determination information RE_ARA corresponding to the first data and the second data. In addition, the VFS 310 receives defragmentation execution determination information RE_ARA, and may vary defragmentation execution information Deflag in response to defragmentation execution determination information RE_ARA. The VFS 310 may transfer the defragmentation execution information Deflag to the storage system 350, and execute defragmentation of a storage device included in the storage system 350.

Since the file management device 300 according to an embodiment of the present inventive concept generates defragmentation execution determination information RE_ARA in the file system 330, and causes the VFS 310 to execute defragmentation, a reading time may be reduced when reading the same portion afterward.

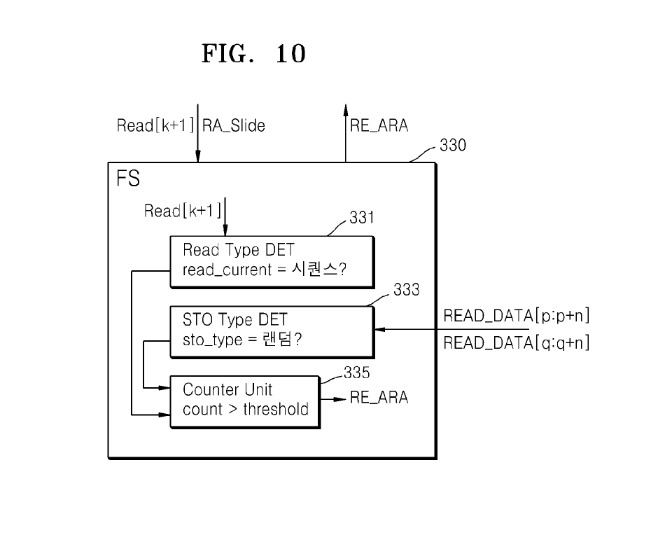

FIG. 10 is a block diagram further illustrating the file system 330 of FIG. 9 according to embodiments of the inventive concept.

Referring to FIG. 10, the file system 330 include a read type determination unit (Read Type DET) 331, a storage type determination unit (STO Type DET) 333, and a count unit (Count Unit) 335.

The read type determination unit 331 receives a read request [k+1], compares a currently received first read request with a previous second read request, and determines whether the first read request and the second read request are sequential.

That is, the read type determination unit 331 may determine whether the currently received first read request is about sequential logical addresses of a file that is the same as a file corresponding to the previously received second read request. The sequential logical addresses of a same file indicate that a logical address value of data subject to the first read request is greater than a logical address value of data subject to the second read request, and that there is no other data for the same file between the logical address value of data subject to the first read request and the logical address value of data subject to the second read request.

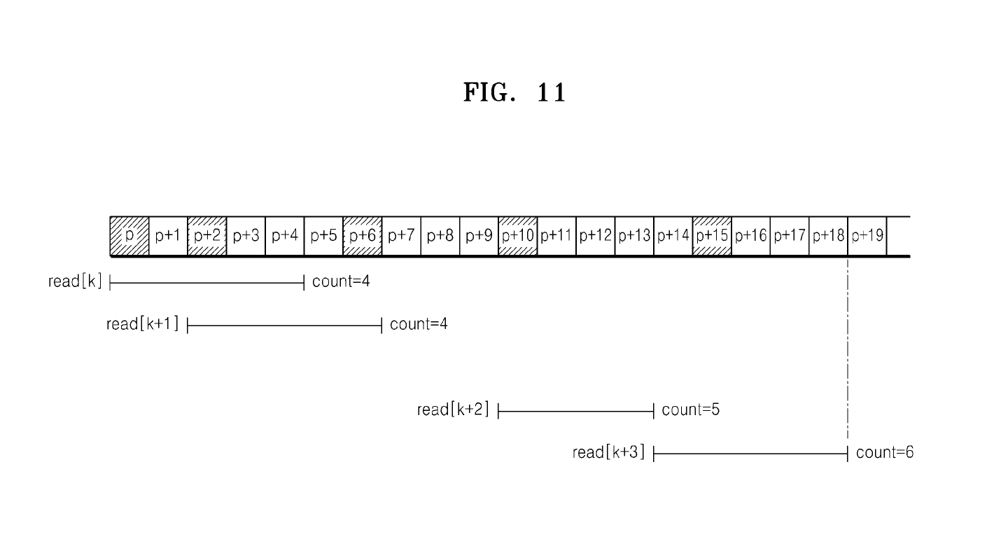

FIG. 11 is a diagram illustrating a status of stored data that further illustrates the operation of the storage type determining unit 333 of FIG. 10. Referring to FIGS. 10 and 11, the storage type determination unit 333 receives first data READ_DATA [p] to READ_DATA [p+n] and second data READ_DATA [q] to READ_DATA [q+n], and determines whether data stored in the storage system are stored randomly.

For example, when data read in response to a read request Read [k] corresponds to READ_DATA [p+4], and data read in response to a read request Read [k=1] corresponds to READ_DATA [p+2] to READ_DATA [p+4], the storage type determination unit 333 determines the storage type to be sequential. In this case, the count unit 335 does not increase count information.

When data read in response to continuous read requests corresponds to READ_DATA [p+9] to READ_DATA [p+13], the storage type determination 333 determines the storage type to be random. In this case, when the read type determination unit 331 determines the read type to be sequential, the count unit 335 increases the counting information by 1. When the counting information increases and exceeds a threshold value, the count unit 335 may generate the defragmentation execution determination information RE_ARA.

Referring to FIG. 10, the count unit 335 determines whether to increase the counting information on the basis of determination results from the read type determination unit 331 and the storage type determination unit 333. For example, when the read type determined by the read type determination unit 331 is sequential and the storage type determined by the storage type determination unit 333 is random, the count unit 335 increases the counting information by 1. When the counting information increases and exceeds a threshold value, the count unit 335 may generate the defragmentation execution determination information RE_ARA.

According to other embodiments of the inventive concept, when the read type determined by the read type determination unit 331 is random and the storage type determined by the storage type determination unit 333 is random, the file system 330 generates RA slide size varying information to reduce the RA slide size information RA_Slide, and the count unit 335 may generate the defragmentation execution determination information RE_ARA. According to still other embodiments of the inventive concept, when the file system 330 is a log-based file system, the defragmentation may be implemented as garbage collection which operates as a background thread. Also, according to still other embodiments of the inventive concept, remapping of an SSD may be used to prevent degradation in defragmentation performance.

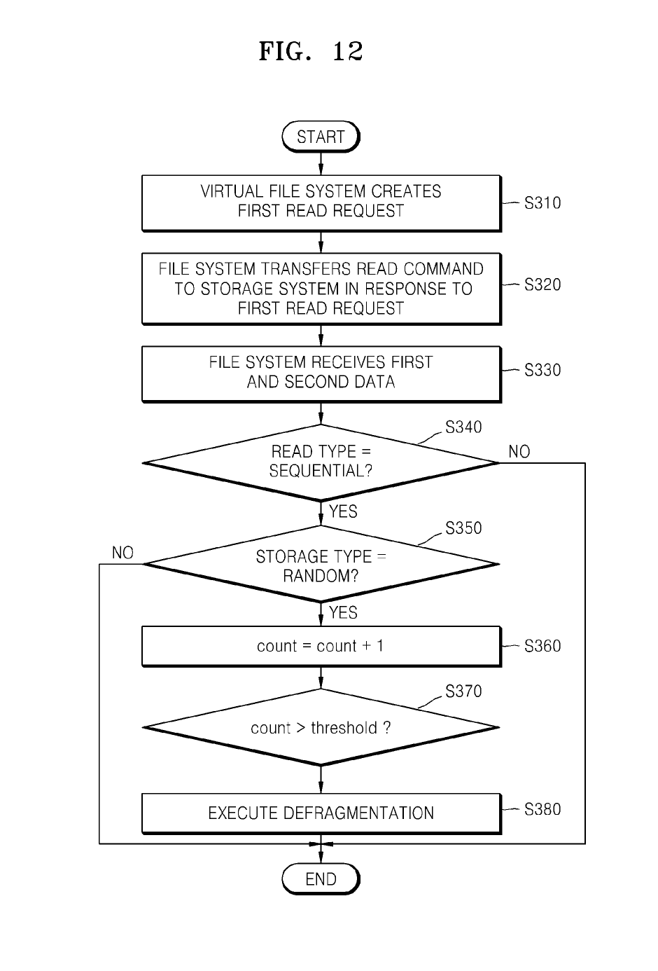

FIG. 12 illustrates a flow chart summarizing a file management method that may be used a file management device of the storage system 300 according to embodiments of the inventive concept.

Referring to FIGS. 9, 10 and 12, the VFS 310 generates a first read request Read [k+1] (S310). The first read request Read [k+1] generated by the VFS 310 is transferred to the file system 330. The file system 330 transfers a read command Read_Command [k+1, 0:k+1, n] to the storage system 350 in response to the first read request Read [k+1] (S320). The storage system 350 may store the read data in the buffer 370 in response to the Read_Command [k+1,0:k+1, n]. The file system 330 receives first data READ_DATA [0] to READ_DATA [p+n] and second data READ_DATA [p] to READ_DATA [p+n] read from the buffer 370 (S230). The file system 330 may generate defragmentation execution determination information RE_ARA in response to the first data and the second data.

In detail, the read type determination unit 331 determines whether the received read request Read [k+1] is sequential (S340).

The storage type determination unit 333 determines whether the storage type is random (S350). When the read request Read [k+1] is sequential and the storage type is random, the count unit 335 increases the counting information by 1 (S360). The count unit 335 determines whether the counting information increases and exceeds a threshold value (S370). When the counting information exceeds the threshold value, the count unit 335 may generate the defragmentation execution determination information RE_ARA (S380).

Since the file management method S300 according to the present embodiment generates defragmentation execution determination information RE_ARA in the file system 330, and causes the VFS 310 to execute defragmentation, a reading time may be reduced when reading the same portion afterward.

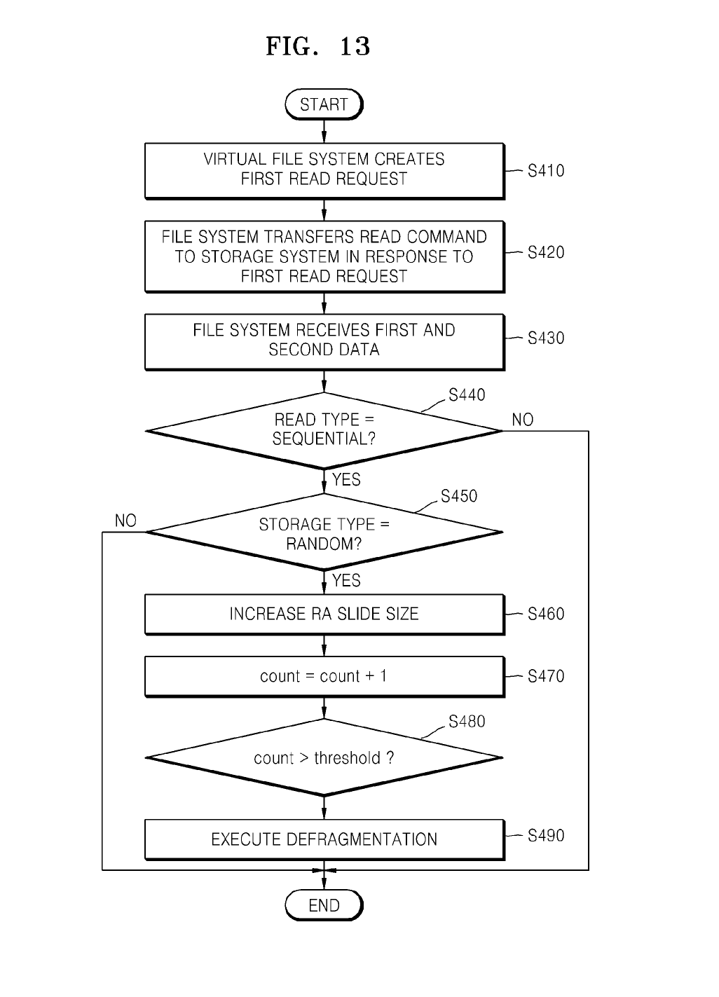

FIG. 13 a flow chart summarizing a file management method using a file management device of a storage system 300 according to certain embodiments of the inventive concept.

Referring to FIGS. 9, 10 and 13, the VFS 310 generates a first read request Read [k+1] (S410). The first read request Read [k+1] generated by the VFS 310 is transferred to the file system 330. The file system 330 transfers a read command Read_Command [k+1, 0:k+1, n] to the storage system 350 in response to the first read request Read [k+1] (420). The storage system 350 may store the read data in the buffer 370 in response to the Read_Command [k+1,0: k+1, n].

The file system 330 receives first data READ_DATA [0] to READ_DATA [p+n] and second data READ_DATA [p] to READ_DATA [p+n] read from the buffer 370 (S430). The file system 330 may generate defragmentation execution determination information RE_ARA and RA slide size varying information in response to the first data and the second data.

In detail, the read type determination unit 331 determines whether the received read request Read [k+1] is sequential (S440). The storage type determination unit 333 determines whether the storage type is random (S450).

When the read request Read [k+1] is sequential and the storage type is random, the RA slide size varying information Slide_Var may be generated to increase the RA slide size varying information (S460).

In addition, when the read request Read [k+1] is sequential and the storage type is random, the count unit 335 increases the counting information by 1 (S470). The count unit 335 determines whether the counting information increases and exceeds a threshold value (S480). When the counting information exceeds the threshold value, the count unit 335 may generate the defragmentation execution determination information RE_ARA (S490).

The file management method S400 according to the present embodiment may generate defragmentation execution determination information RE_ARA and RA slide size varying information in the file system 330, and manage the RA mechanism to be appropriate for a read access pattern. Since the file management method S400 causes the VFS 310 to execute the defragmentation, a reading time may be reduced when reading the same portion afterward.

While the inventive concept has been particularly shown and described with reference to exemplary embodiments thereof, it will be understood that various changes in form and details may be made therein without departing from the scope of the following claims.

What is claimed is:

1. A file management device for a storage system, comprising:
a virtual file system (VFS) having a read-ahead (RA) management unit that stores RA management information and configured to generate a current read request (“first read request”); and
a file system configured to receive first read data in response to the current read request and second read data in response to a previously received read request (“second read request”), compare the first and second read data to generate varying information related to the RA management information, and provide the varying information to the VFS,
wherein the VFS is further configured to update the RA management information in response to the varying information.

2. The device of claim 1, wherein the RA management information is RA slide size information, and the varying information is RA slide size varying information.

3. The device of claim 2, wherein the file system comprises:
a read type determination unit that determines whether the first read request is sequentially generated;
a storage determination unit that determines whether the first and second data are sequentially stored in the storage system; and
a slide size determination unit that generates the RA slide size varying information in response to determinations made by the read type determination unit and the storage type determination unit.

4. The device of claim 3, wherein the read type determination unit is configured to compare the first and second read requests to determine whether the first and second read requests are sequential when the first and second read requests have sequential logical addresses.

5. The device of claim 3, wherein the storage type determination unit is configured to determine that the first and second data are not sequentially stored when no data identical to that of the first data is found in the second data.

6. The device of claim 2, wherein the file system is further configured to generate the slide size varying information by fetching from a buffer at least a portion of first data and at least a portion of the second data.

7. The device of claim 2, wherein the VFS updates the RA slide size information in response to the RA slide size varying information.

8. The device of claim 1, wherein the RA management information is defragmentation execution information for data stored in the storage system, and the varying information is defragmentation execution determination information.

9. The device of claim 8, wherein the file system comprises:
a read type determination unit that determines whether the first read request is sequentially generated;
a storage type determination unit that determines whether the first data is sequentially stored in the storage system with respect to the second data; and
a count unit that determines counting information in response to results of the determinations made by the read type determination unit and the storage type determination unit, wherein the defragmentation execution determination information is determined in response to the counting information.

10. The device of claim 8, wherein the VFS varies the defragmentation execution information of data included in the storage system in response to the defragmentation execution determination information.

11. A method of managing files stored in a storage system using a file management device including a virtual file system (VFS) and a file system, the method comprising:
generating a first read request using the VFS;
using the file system, reading first read data in response to the first read request and current read-ahead (RA) management information and comparing the first read data with second read data previously stored in storage system; and
generating varying information in the file system based on the comparison of the first and second read data and communicating the varying information from the file system to the VFS; and
updating the RA management information in the VFS in response to the varying information.

12. The method of claim 11, wherein the RA management information is RA slide size information and the varying information is RA slide size varying information.

13. The method according to claim 12, wherein the generating of the varying information comprises:
determining whether the first read request is sequentially generated;
determining whether the first and second read data are sequentially stored in the storage system; and
generating the RA slide size varying information in response to the determination of whether the first read request is sequentially generated, and the determination of whether the first and second read data are sequentially stored in the storage system.

14. The method of claim 12, wherein the RA management information is defragmentation execution information and the varying information is defragmentation execution determining information.

15. The method according to claim 14, wherein the generating of the varying information comprises:
determining whether the first read request is sequentially generated;
determining whether the first and second read data are sequentially stored in the storage system;
determining counting information in response to the determination of whether the first read request is sequentially generated, and the determination of whether the first and second read data are sequentially stored in the storage system; and
determining the defragmentation execution determination information in response to the counting information.

16. A method of managing files stored in a storage system using a file management device including a virtual file system (VFS) and a file system, the method comprising:
executing in the VFS a read-ahead (RA) scheme based on current RA management information to predict data stored in the storage system to be next accessed, wherein the current RA management information is defined in relation to a first data pattern of first data stored in the storage system;
reading second data stored in the storage system having a second data pattern different from the first data pattern using the file system;
generating varying information in the file system based on a comparison of the first and second data patterns and communicating the varying information from the file system to the VFS; and
updating the current RA management information in the VFS in response to the varying information to generate new RA management information.

17. The method of claim 16, wherein each one of the current RA management information and the new RA management information is RA slide size information, and the varying information is RA slide size varying information.

18. The method of claim 16, wherein each one of the current RA management information and the new RA management information is defragmentation execution information, and the varying information is defragmentation execution determining information.

19. The method of claim 16, wherein the storage system is one of a solid-state drive (SSD) and a hard-disk drive (HDD).
